(19) United States
(12) Patent Application Publication
(10) Pub. No.: US 2002/0105717 A1
(43) Pub. Date: Aug. 8, 2002

(54) Method for amplifying optical signals

(76) Inventor: Peter Krummrich, Muenchen (DE)

Correspondence Address: BELL, BOYD & LLOYD, LLC, P. O. BOX 1135, CHICAGO, IL, 60690-1135, US

(21) Appl. No.: 10/002,843

(22) Filed: Nov. 14, 2001

(30) Foreign Application Priority Data
Nov. 14, 2000 (DE) 100 56 327.9

(51) Int. Cl. H01S 3/00

(52) U.S. Cl. 359/334

(57) ABSTRACT

For amplification of optical signals which are transmitted via an optical transmission medium, at least one optical pump signal is injected in the transmission direction into the optical transmission medium in order to produce the Raman effect. In this case, the spectral power density, which relates to the optical signal wavelength band, of the at least one optical pump signal is reduced via at least one filter unit such that the remaining spectral power density is below the shot noise limit.

### BACKGROUND OF THE INVENTION

The present invention relates to a method for amplifying optical signals which are transmitted via an optical transmission medium, with at least one optical pump signal being injected in the transmission direction into the optical transmission medium in order to produce the Raman effect.

In existing optical transmission systems, in particular optical transmission systems operating using the WDM principle (wavelength division multiplexing), optical pump signals from a pump source are injected, for example, into an optical monomode fiber codirectionally or contradirectionally, in order to supply the optical amplifiers located upstream or downstream of the injection location with the necessary optical pump power. In a corresponding manner, such optical pump signals are used for direct amplification of optical signals to be transmitted, with the optical amplification produced by the optical pump signals being based on the Raman effect. The Raman effect, or stimulated Raman scatter, is described, for example, in Godwin P. Agrawal “Non-linear Fiber Optics”, Second Edition, 1995, on pages 329 to 334.

Furthermore, concepts for distributed Raman amplification in the optical transmission fiber are known, which allow a considerable improvement in the transmission characteristics of the optical transmission system by distribution of the amplification points over a part of, or over the entire, optical transmission path. By way of example, the use of the distributed Raman amplification technique at the fiber end or at the end of the transmission path section allows an improved optical signal-to-noise ratio (OSNR), which is constant over the WDM channels, to be achieved. As a result, the length of the optical transmission path sections which can be bridged without regeneration can be increased, and more optical transmission path sections can be bridged.

In optical transmission systems with bidirectional data transmission in the optical transmission fibers, Raman pump sources are used both at the fiber input and at the fiber output, in order to produce the pump signals to be provided for the distributed Raman amplification, and in order to make use of the signal-to-noise ratio improvement. The described Raman pump sources are used to pump the incoming WDM channels at the respective fiber ends contradirectionally and, thus, to raise the signal levels of the optical WDM transmission signals to be amplified, in the transmission fiber, before reaching the respective end of the optical transmission path. This results in the described improvement in the signal-to-noise ratio of the respective optical WDM transmission signal. At the same time, the respective Raman pump source is used, during bidirectional operation of the optical transmission fiber, to pump the respective codirectional WDM channels which are also injected at the fiber end. This additional codirectional pumping of the WDM channels, or optical WDM transmission signals, transmitted in the same transmission direction can lead to a deterioration in the signal quality of the optical WDM channels or WDM signals transmitted in the optical transmission fiber, thus resulting in a deterioration of the transmission quality of the entire optical transmission system.

Coupling over the intensity noise of the optical pump radiation into the optical WDM channels within the optical transmission fiber results in the deterioration in the signal quality of the WDM channels, particularly in the case of a codirectional pumped Raman amplifier arrangement. Since the effect of stimulated Raman scatter, which is made use of in the codirectionally pumped Raman amplifier arrangement, is implemented with time constants in the femtosecond range, modulation of the optical pump radiation in the entire signal frequency band results in the intensity noise of the optical pump radiation being coupled over directly to the signal radiation.

Furthermore, a codirectionally pumped Raman amplifier arrangement which is operated in the saturation region can lead to bit-pattern-dependent coupling between the optical WDM signals. If the input levels are correspondingly high and the gain of the optical Raman amplifier is high, the attenuation of the pump radiation per optical transmission fiber length is dependent on the intensity of the signal radiation. If a logic “1” is transmitted in a time interval under consideration using binary intensity modulation by all the WDM channels or WDM signals, then the pump radiation is more heavily attenuated than when a logic “1” is transmitted in only a single WDM channel or WDM signal. Increased attenuation of the optical pump radiation leads to less amplification via the optical Raman amplifier. A logic “1” in a given WDM channel or WDM signal is thus amplified less, assuming that the large number of other WDM channels or WDM signals likewise have a binary “1” within the same time interval, thus resulting in bit-pattern-dependent intensity modulation of the WDM channels or WDM signals. In order to avoid such bit-pattern-dependent crosstalk, the optical Raman amplifier arrangement shall be operated below its saturation limit.

In addition, the optical pump signal sources of the optical Raman amplifier arrangement generate not only the coherent radiation at the wavelength of the optical pump signal but also incoherent spectral components, which can be distributed over a very wide wavelength band. Such incoherent spectral components of the optical pump signals are produced by spontaneous emission of the laser transition of the respective optical pump source, in which case a portion of the spontaneously emitted optical radiation can affect the signal wavelength band. If this spontaneously emitted radiation is injected into the optical transmission fiber, and thus into the wavelength band of the optical WDM transmission signal, then it is superimposed there on the amplified spontaneous emission of the optical Raman amplifier arrangement. In a similar way to the spontaneous emission of the optical Raman amplifier arrangement, the spontaneous emission, caused by the optical pump signals, in the amplifying fiber will be mixed with the optical WDM transmission signal, thus generating new noise components which are added to the optical transmission signal. Such superimposition in the optical transmission fiber can take place especially if the optical Raman amplifier arrangement is being pumped codirectionally. This results in a need for optical Raman pump signal sources for codirectional pumping in the optical signal waveband, whose optical pump signals generate very little spontaneous emission, and couple very little such spontaneous emission into the optical WDM transmission signal. Such requirements for optical pump signal sources have not been taken into account in the design of Raman amplifier arrangements known to date, since they are normally designed only for contradirectional pumping of optical WDM transmission signals.

Accordingly, an object to which the present invention is directed is to specify a method for amplifying optical signals making use of the Raman effect, in which the signal quality of the at least one optical pump signal required to produce the Raman effect is improved.

### SUMMARY OF THE INVENTION

A major aspect of the method according to the present invention, therefore, is that the spectral power density, which relates to the optical signal wavelength band, of the at least one optical pump signal is reduced via at least one filter unit such that the remaining spectral power density is below the shot noise limit. The reduction in the incoherent spectral components contained in the optical Raman pump signal advantageously prevents superimposition of these incoherent spectral components on the optical transmission signal, thus making it possible to avoid a reduction in the quality of the optical transmission signal. Any reduction in the spectral power density under consideration of the optical Raman pump signals at the wavelength of the optical transmission signal below the shot noise limit, that is to say a spectral power density of -58 dBm with respect to 0.1 nm, is sufficient to ensure that the spontaneous emission generated by the Raman pump sources is negligible in comparison to the spontaneous emission generated by the optical Raman amplifier arrangement in the signal path.

The spectral power density of the at least one optical pump signal is advantageously reduced via at least one filter unit before or during the injection into the optical transmission medium. According to the present invention, at least one optical filter unit is provided in order to reduce the spectral power components of the optical Raman pump signal or signals, whose insertion loss attenuates the incoherent spectral components of the optical Raman pump signal, which are, for example, in the signal wavelength band from 1400 to 1610 nm, so severely that they are below the shot noise limit.

Additional features and advantages of the present invention are described in, and will be apparent from, the following Detailed Description of the Invention and the Figures.

### BRIEF DESCRIPTION OF THE FIGURES

FIG. 1 shows, by way of example, the basic design of a Raman amplifier arrangement according to the present invention, with a filter unit.

FIG. 2 shows, by way of example, the basic design of an alternative Raman amplifier arrangement according to the present invention, with a number of filter units.

FIG. 3 shows, by way of example, the basic design of a further Raman amplifier arrangement according to the present invention, with a combined optical coupling and filter unit.

### DETAILED DESCRIPTION OF THE INVENTION

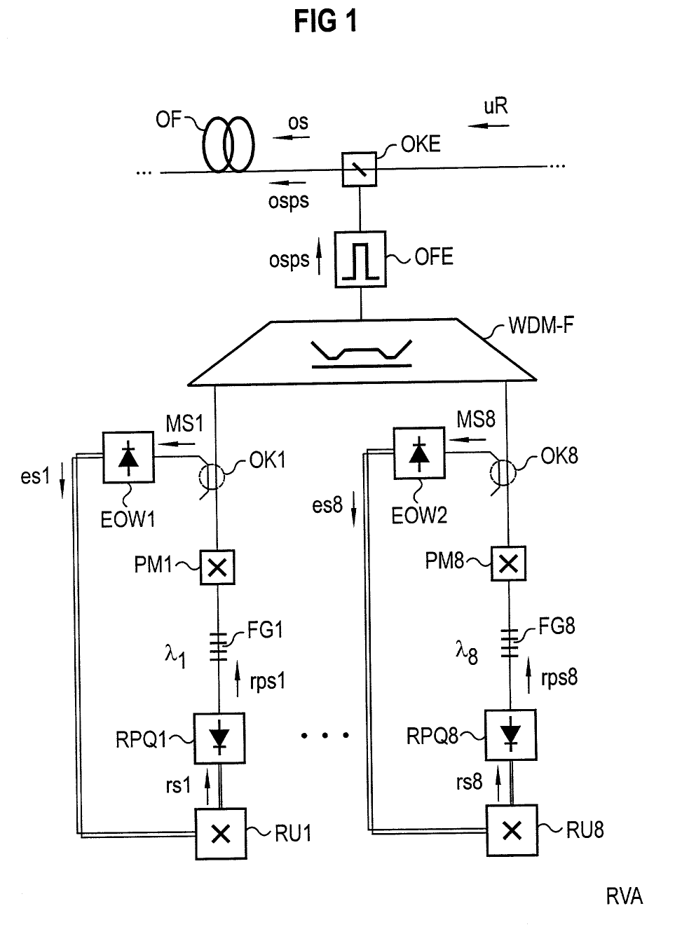

By way of example, FIG. 1 shows a Raman amplifier arrangement RVA which has an optical transmission fiber OF, an optical coupling unit OKE, an optical filter unit OFE and a WDM frequency filter WDM-F. The WDM frequency filter WDM-F is connected to eight Raman pump sources RPQ1 through RPQ8 in order to produce eight optical Raman pump signals rpsl through rps8. Each of the eight Raman pump sources RPQ1 through RPQ8 is connected via a fiber grating FG1 through FG8 and a polarization mixer PM1 through PM8 and an optical coupler OK1 through OK8 to one input of the WDM frequency filter WDM-F. The first to eighth optical couplers OK1 through OK8 are connected to first to eighth electrooptical transducer units EOW1 through EOW8, each of whose outputs is connected to a first to eighth control unit RU1 through RU8. The first to eighth control units RU1 through RU8 are connected to the associated first to eighth Raman pump sources RPQ1 through RPQ8 in order to control them.

By way of example, FIG. 1 shows only a first and an eighth Raman pump source RPQ1,RPQ8 and the associated first and eighth fiber gratings FG1, FG8, the first and eighth polarization mixers PM1, PM8, a first and an eighth optical coupler OK1, OK8, and a first and an eighth electrooptical transducer unit EOW1, EOW8, with the other Raman pump source arrangement being indicated by a dotted line.

The first through eighth Raman pump sources RPQ1-RPQ8 are used to produce first through eighth optical Raman pump signals rps1-rps8, which are each at different first through eighth wavelengths λ1-λ8. The production and stabilization of the first through eighth optical Raman pump signals rps1 through rps8 will be explained, by way of example, with reference to the first optical Raman pump signal rps1. The first wavelengths λ1 of the first optical Raman pump signal rps1 are stabilized by the first fiber grating FG1. The first optical Raman pump signal rps1 is then transmitted to the first polarization mixer PM1, which is intended for “scrambling” the polarization of the first optical Raman pump signal rps1. The first optical Raman pump signal rps1, stabilized and processed in this way, is transmitted via the first optical coupler OK1 to one input of the WDM frequency filter WDM-F. The first optical coupler OK1 is used to output a first measurement signal MS1 from the first optical Raman pump signal rps 1, which is supplied to the first electrooptical transducer unit EOB1. Such a first optical coupler OK1 may be designed, for example, as an optical fiber coupler with a coupling ratio of, for example, 2% to 98%. Only a small portion of the first optical Raman pump signal rps1 is thus output as the first measurement signal MS1 while, in contrast, the rest of the first optical Raman pump signal rps1 is coupled via the optical filter unit OFE and the optical coupling unit into the optical fiber OF at the WDM frequency filter WDM-F.

The first electrooptical transducer EOW1 is used to produce a first electrical signal es1, which is supplied to the first control unit RU1, in which the first electrical signal es1 is used to form a first control signal rs1. The first control signal rs1 is then transmitted to the first Raman pump source. The first control signal rs 1 is used to control the injection currents of the laser diodes in the first Raman pump source RPQ1, such that the power levels of the first optical Raman pump signal rpsl are constant before being supplied to the WDM frequency filter WDM-F.

The second through eighth optical Raman pump signals rps2 through rps8 are produced and controlled at a constant power level in an analogous manner to this. The first through eighth optical Raman pump signals rps1-rps8 are combined via the WDM frequency filter WDM-F to form an optical total pump signal osps which is transmitted to the optical filter unit OFE according to the present invention. According to the present invention, the spectral power density, which relates to the signal wavelength band, of the optical total pump signal osps is reduced to a sufficiently great extent in the optical filter unit OFE that the spectral power density under consideration of the optical total pump signal osps is below the shot noise limit. Reducing this spectral power density below the shot noise limit, that is to say below a power level of −58 dBm with respect to 0.1 nm, is sufficient to ensure that the spontaneous emission generated by the first through eighth Raman pump sources RPQ1 through RPQ8 in the signal wavelength band is negligible in comparison to the spontaneous emission generated by the optical amplifiers on the optical transmission path. The optical total pump signal osps filtered in this way is injected into the optical fiber or the optical transmission fiber OF in the transmission direction UR of the optical transmission signal os via an optical coupling unit OKE; for example, an optical bandpass filter. In consequence, the Raman amplifier arrangement RVA is pumped codirectionally by the first through eighth optical Raman pump signals rpsl through rps8 which are produced in the first through eighth Raman pump sources RPQ1-RPQ8, thus resulting in Raman amplification of the optical transmission signal os in the optical transmission fiber OF.

According to the present invention, the filtering of the optical total pump signal osps and the reduction of the spectral power density of the optical total pump signal osps in the signal wavelength band of the optical transmission signal os suppress and attenuate the incoherent radiation, which is generated by the spontaneous emission of the laser transition, from the first through eighth optical Raman pump signals rps1-rps8. For this purpose, the optical filter unit OFE may, for example, be in the form of a bandpass filter or a bandstop filter, with the insertion loss of the optical filter unit OFE being approximately 0.5-1 dB in the pump wavelength band (1,400-1,550 nm) between the WDM frequency filter WDM-F and the optical coupler unit OKE, and with the insertion loss being considerably more than 20 dB at all other wavelengths, especially in the signal wavelength band (1,530-1,610 nm).

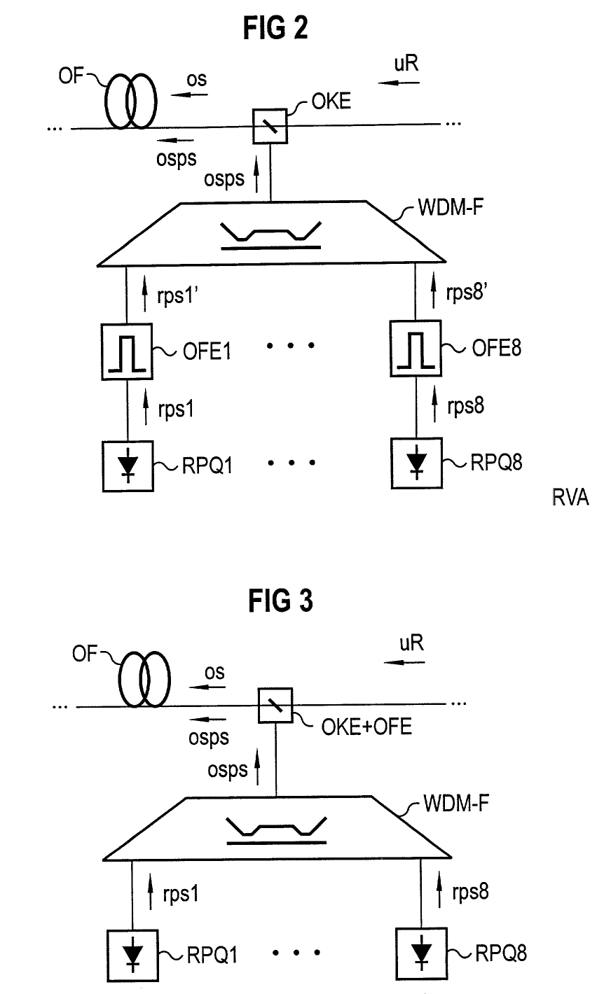

By way of example, FIG. 2 shows a further refinement of the Raman amplifier arrangement RVA according to the present invention in which, in contrast with FIG. 1, shows a further alternative to the arrangement of the filter unit OFE according to the present invention for reducing the spectral power density, which relates to the optical signal waveband, of the at least one optical pump signal rps1-rps8. To this end, figuratively, the optical filter unit OFE shown in FIG. 1 has been shifted via the WDM frequency filter WDM-F into the individual pump signal production paths, so that a dedicated optical filter unit OFE1-OFE8 is now provided for each individual pump signal production path. The first through eighth optical filter units OFE1-OFE8 are used to provide separate filtering and reduction of the spectral power density, which relates to the signal wavelength band of, for example, about 1400 to 1610 nm, of the first through eighth optical Raman pump signals rps1 to rps8. For this purpose, for example, the first Raman pump source RPQ1 is connected via the first optical filter unit OFE to the WDM frequency filter WDM-F, and the eighth Raman pump source RPQ8 is connected via the eighth optical filter unit OFE to the WDM frequency filter WDM-F. The second through seventh optical filter units OFE2 through OFE8 are connected to the WDM frequency filter WDM-F in an analogous manner, although this is not shown explicitly in FIG. 2, but is indicated by a dotted line.

The filtered first through eighth optical Raman pump signals rps1-rps8 are transmitted to the WDM frequency filter WDM-F in an analogous manner to the method illustrated in FIG. 1, where they are combined to form an optical total pump signal osps which is transmitted to the optical coupling unit OKE. The optical coupling unit OKE is used to inject the optical total pump signal osps into the optical transmission fiber OF, in the same transmission direction UR as the optical transmission signal os.

The power control, illustrated in FIG. 1, of the first through eighth Raman pump sources RPQ1-RPQ8 is not shown explicitly in FIG. 2, in a similar way to the first through eighth fiber gratings FG1-FG8 and the first through eighth polarization mixers PM1-PM8.

The exemplary embodiment illustrated in FIG. 3 shows an alternative implementation of the amplification of optical signals according to the present invention, in which the reduction in the spectral power component, which relates to the optical signal wavelength band, of the at least one optical pump signal rps1-rps8 is carried out via a combined optical coupling and filter unit OKE+OFE. The illustrated combined optical coupling and filter unit OKE+OFE has an optical filter function in addition to the optical coupling function, by which the optical total pump signal osps produced by the WDM frequency filter WDM-F is first of all filtered, and is then injected into the optical transmission fiber OF in the same transmission direction UR as the optical transmission signal os. The first through eighth optical Raman pump signals rps1 through rps8 are produced in the first through eighth Raman pump sources RPQ1 through RPQ8, and are transmitted to the WDM frequency filter WDM-F, in an analogous manner to the method illustrated in FIG. 1 or FIG. 2. Analogously to FIG. 2, FIG. 3 shows only the first and eighth Raman pump sources RPQ1, RPQ8, with the second through seventh Raman pump sources RPQ2 through RPQ7 being indicated by a dotted line.

The combined optical coupling and filter unit OKE+OFE illustrated in FIG. 3 may also be in the form of an optical bandpass filter with an optical filter function, in which case the filter unit contained in it has an insertion loss of less than 1 dB in the pump waveband, and has an insertion loss of more than 25 dB in the signal wavelength band. The combined optical coupling and filter unit OKE+OFE illustrated in FIG. 3 thus strongly couples only spectral components in the pump wavelength band into the signal path and the optical transmission fiber OF. Those spontaneously emitted power components of all the Raman pump signals rps1 through rps8 and of the entire optical total pump signal osps which are in the signal wavelength band are coupled over only weakly, so that this spectral power density is below the shot noise.

By way of example, the first optical Raman pump signal RPS1 has an output power upstream of the optical filter unit OFE of, for example, 23 dBm with respect to 0.1 nm. The laser line gap for spontaneous emission is 60 dB with respect to 0.1 nm, that is to say, upstream of the filter unit OFE, the spontaneous emission in the signal wavelength band has a spectral power density of about −37 dBm with respect to 0.1 nm. The optical filter unit OFE reduces the spectral power density of the first optical Raman pump signal rpsl to, for example, −62 dBm with respect to 0.1 nm, and thus below the shot noise limit. This makes it possible to avoid the disturbing coupling of the coherent radiation components, which affect the signal wavelength band, within the optical transmission system.

Although the present invention has been described with reference to specific embodiments, those of skill in the art will recognize that changes may be made thereto without departing from the spirit and scope of the invention as set forth in the hereafter appended claims.

1. A method for amplifying optical signals which are transmitted via an optical transmission medium, the method comprising the steps of:
injecting at least one optical pump signal in a transmission direction into the optical transmission medium to produce a Raman effect; and
reducing a spectral power density, which relates to an optical signal wavelength band, of the at least one optical pump signal via at least one filter unit wherein a remaining spectral power density is below a shot noise limit.

2. A method for amplifying optical signals which are transmitted via an optical transmission medium as claimed in claim 1, wherein the step of reducing occurs at a time which is one of before and during the step of injecting the at least one optical pump signal into the optical transmission medium.

3. A method for amplifying optical signals which are transmitted via an optical transmission medium as claimed in claim 1, wherein, given a plurality of optical pump signals, the respective spectral power density of each of the plurality of optical pump signals is respectively reduced via a respective filter unit, the plurality of remaining spectral power densities being combined to form an optical total pump signal before being injected into the optical transmission medium.

4. A method for amplifying optical signals which are transmitted via an optical transmission medium as claimed in claim 1, wherein a plurality of optical pump signals are combined to form an optical total pump signal, and the spectral power density of the optical total pump signal is reduced via a filter unit.

5. A method for amplifying optical signals which are transmitted via an optical transmission medium as claimed in claim 4, wherein the spectral power density of the optical total pump signal is reduced via an optical bandpass filter for injection into the optical transmission medium.

6. A method for amplifying optical signals which are transmitted via an optical transmission medium as claimed in claim 4, wherein the at least one filter unit attenuates the at least one optical pump signal and the optical total pump signal by less than 1 dB in the a pump wavelength band, and by more than 25 dB in the signal wavelength band.
